(19) United States
(12) Patent Application Publication
(10) Pub. No.: US 2010/0175122 A1
(43) Pub. Date: Jul. 8, 2010

(54) SYSTEM AND METHOD FOR PREVENTING HEADER SPOOFING

(75) Inventor: STEPHEN R. BALLARD, PLANO, TX (US)

Correspondence Address: VERIZON;PATENT MANAGEMENT GROUP, 1320 North Court House Road, 9th Floor, ARLINGTON, VA, 22201-2909, US

(73) Assignee: VERIZON CORPORATE RESOURCES GROUP LLC, BASKING RIDGE, NJ (US)

(21) Appl. No.: 12/350,881

(22) Filed: Jan. 8, 2009

(51) Int. Cl. H04L 9/32

(52) U.S. Cl. 726/12

(57) ABSTRACT

A system and method for preventing spoofing including a receiver at a session border controller (SBC) configured to receive a message from a network element, wherein the message is a request for network access and the message comprises a first source information. The system and method may also include one or more processors at the session border controller (SBC) configured to identify an identifier associated with the network element, wherein the identifier corresponds to a second source information, and to replace the first source information in the message received from the network element with the second source information corresponding to the identifier of the network element. The system and method may also include one or more databases configured to store the second source information. The system and method may also include a transmitter at the session border controller (SBC) configured to transmit the message with the second source information to a service provider proxy for granting network access. In another embodiment, network access may be denied in the event it is determined that the first source information in the message received from the network element with the second source information corresponding to the identifier of the network element are different.

### BACKGROUND INFORMATION

“Spoofing” of electronic communications may be accomplished by altering one or more headers of data packets to misrepresent an originator of data communications, a destination of data communications, or other metadata associated with the data communications. Spoofing of data communications may enable a person to gain unauthorized access to network resources, to deceive network users, and/or to accomplish other improper purposes. Spoofing may occur accidentally or maliciously. Prevention of such spoofing may enable more secure network communications for a variety of purposes, such as secure communications over packet-switched networks, e.g., Voice over Internet Protocol (VoIP) communication or other similar communication.

VoIP is a protocol optimized for the transmission of voice through the Internet or other packet-switched networks. In general, when a VoIP subscriber/user desires to make a phone call or access the Internet over the VoIP service, a service provider may receive a message from the subscriber's communication device (e.g., phone). In the message, there may be a header portion which identifies the subscriber's source (e.g., an IP address). This header information may be provided by the subscriber's communication device when the subscriber attempts to make the phone call or otherwise access the Internet provided by the service provider. If the service provider recognizes the source as it is presented in the header portion of the message, network access may be granted and the subscriber, for example, may continue with the phone call. However, as described above, there may be situations where a party may pretend to be the subscriber by sending a message to the service provider with a spoofed header portion, falsely indicating that it is the recognized subscriber. As a result, the service provider may believe the party sending the spoofed header is a subscriber and allow network access to the spoofing party. Because conventional systems and methods lack a technique to comprehensively and effectively prevent these “spoofs,” network security may be compromised.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for preventing header spoofing, according to an exemplary embodiment;

FIG. 2 depicts a block diagram of a session border controller (SBC) for preventing header spoofing, according to an exemplary embodiment;

FIG. 3 depicts a flowchart of a method for preventing header spoofing using a session border controller (SBC), according to an exemplary embodiment; and

FIG. 4 depicts a flowchart of a method for preventing header spoofing using session border controller (SBC), according to another exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for preventing header spoofing. That is, exemplary embodiments may, among other things, expand and optimize packet networks (e.g., VoIP, etc.) to effectively provide secure communication using techniques for prevention of header spoofing.

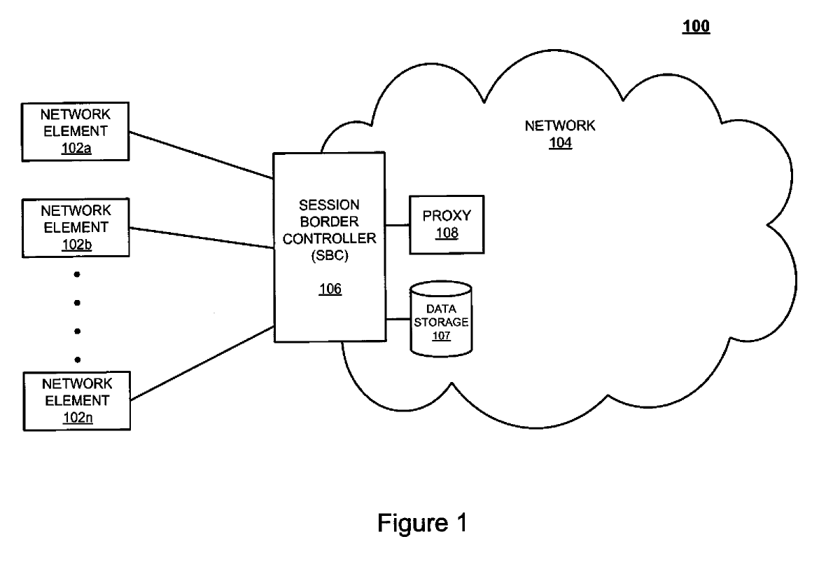

FIG. 1 depicts a block diagram of a system architecture for header spoofing prevention 100, according to an exemplary embodiment. It should be appreciated that system 100 is a simplified view for header spoofing prevention and may include additional elements that are not depicted. As illustrated, the system 100 may include one or more network elements 102a, 102b, . . . 102n. Each network element may be customer premise equipment (CPE), subscriber equipment, and/or other network user owned equipment. The network elements 102a, 102b, . . . 102n may be operated by a customer, subscriber, and/or network user and may be communicatively coupled to a network 104. In order to access the network 104, the network elements 102a, 102b, . . . 102n may be communicatively coupled to a session border controller (SBC) 106, which may be located logically at the edge of the network 104. It should be appreciated that the session border controller (SBC) 106 may be communicatively coupled to a proxy 108, which may grant/deny each of the one or more network elements 102a, 102b, . . . 102n access to one or more resources within, of, and/or through the network 104.

Each of the network elements 102a, 102b, . . . 102n may be a communication system and/or device, such as a private branch exchange (PBX), a router, a switch, and/or other communication device. It should also be appreciated that the network element 102 may be a customer premise equipment (CPE) or a variety of other systems and/or devices capable for use in communications. These may include desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals. It should be appreciated that the network element 102 may be mobile, handheld, or stationary. It should also be appreciated that the network element 102 may be used independently or may be used as an integrated component in another device and/or system. It should also be appreciated that the network element 102 may be physical and/or virtual and may also be a network itself.

The network 104 may be any network, such as a local area network (LAN), a wide area network (WAN), a service provider network, the Internet, or other similar network. In some embodiments, the network 104 may be a service provider network. It should be appreciated that the network may use electric, electromagnetic, and/or optical signals that carry digital data streams.

The session border controller (SBC) 106 may be a computer, module, server, device, or other similar component that is located logically on the edge of the network 104, for which a network element 102 seeks access. It should be appreciated that while the session border controller (SBC) 106 is described as being located at the edge of the network 104 to operate as a gateway to the network 104, other various embodiments may also be provided. For example, the session border controller (SBC) 106 may be located inside or outside the network 104 and may be utilized in greater or lesser capacity than as a gateway to the network 104.

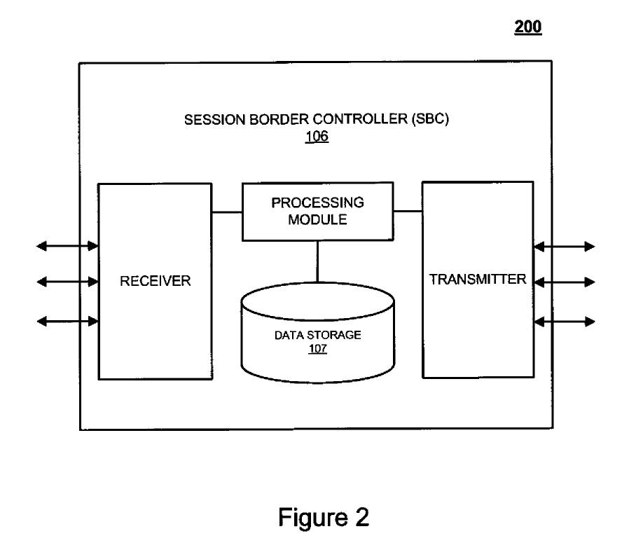

FIG. 2 depicts a block diagram of a session border controller (SBC) for preventing header spoofing 200, according to an exemplary embodiment. In this example, the session border controller (SBC) 106 may include at least one receiver, one or more processors communicatively coupled to one or more data storage 107, and at least one transmitter. Other various embodiments may also be provided.

The proxy 108 may be a Session Initiation Protocol (SIP) proxy server or other similar server/module/device to provide network connectivity (e.g., a dial tone) to the network element 102. In some embodiments, the proxy 108 may provide network service and/or network connection to the network element 102 when authenticated by the session border controller (SBC) 106. It should be appreciated that while the proxy 108 is described as being located within the network 104, other various embodiments may also be provided. For example, the proxy 108 may be located inside or outside the network 104 and may be utilized in greater or lesser capacity to grant/deny access to the network 104.

In some embodiments, the session border controller (SBC) 106 and/or proxy 108 may be a centralized system including one or more processors (not shown) where one or more messages received from network elements 102 having associated users may be received in order to access network/platform in which the centralize system is situated. Accordingly, the session border controller (SBC) 106 and/or proxy 108 may store and/or provide information (e.g., unique identifiers) associated with those network users and/or devices having access to the network/platform.

Additionally, the session border controller (SBC) 106 and/or proxy 108 may include an SQL Server, UNIX based servers, Windows 2000 Server, Microsoft IIS server, Apache HTTP server, API server, Java sever, Java Servlet API server, ASP server, PHP server, HTTP server, Mac OS X server, Oracle server, IP server, and/or other independent server to prevent spoofing. Also, the session border controller (SBC) 106 and/or proxy 108 may store and/or run a variety of software, for example, Microsoft .NET framework, etc.

The data and/or information provided by the session border controller (SBC) 106 and/or proxy 108 may be stored and/or indexed in one or more databases 107. The one or more databases may be communicatively coupled and/or be a part of the network 104 or other source (not shown). In this example, the session border controller (SBC) 106 and/or proxy 108 may store data and/or information (e.g., unique identifier of the network element 102) associated with those network users having access to the network/platform. The session border controller (SBC) 106 and/or proxy 108 may be in communication with other components of the system 100 as well. In addition to preventing spoofing when allowing network access, the session border controller (SBC) 106 and/or proxy 108 may also provide, record, store, and/or index other security-related data and/or information.

Although each of the session border controller (SBC) 106 and proxy 108 is depicted as one component, it should be appreciated that the contents of the session border controller (SBC) 106 and/or proxy 108 may be combined into fewer or greater numbers of modules, servers (or server-like devices), devices, and components and may be connected to one or more data storage systems (not shown). Furthermore, each of the session border controller (SBC) 106 and proxy 108 may be local, remote, or a combination thereof to each other and/or to one or more network elements 102. The session border controller (SBC) 106 and/or proxy 108 may also store additional data and/or information relevant for personalized security functionalities.

As discussed above, the proxy 108 may be configured to trust any header portion of a message (even for non-registered network elements). Accordingly, a network element 102 of a spoofing party may be recognized by the proxy 108 as a network element 102 of a customer/subscriber in the event the network element 102 of the party sends a message where the header portion of the message identifies the party as the customer/subscriber of the network 104. As a result, the actual customer/subscriber identified by the proxy 108 may be charged for call routing and/or billed for network access conducted by the spoofing party. More harmful security issues may also be presented by such spoofing techniques.

Accordingly, exemplary embodiments may provide a session border controller (SBC) 106 that is configured to prevent “spoofing.” The session border controller (SBC) 106 may be configured to manipulate content of one or more portions of a message (e.g., a header portion of the message) received from a network element 102 to prevent spoofing of the proxy 108. For example, in some embodiments, a network access request message (e.g., SIP INVITE) may come from a network element 102a. The network element may have a specific or unique identifier, such as an IP address, a vLAN tag, or other unique identifier. The network access request message may include a portion where this unique identifier may be encoded. A spoofed message header may include information associated with a source that does not match that of the network element 102a that is transmitting the network access request message to the session border controller 106. Accordingly, in order to prevent spoofing, the session border controller (SBC) 106 may unconditionally substitute a portion of the message with the information associated with the unique identifier, which the session border controller (SBC) 106 knows is associated with the network element 102a actually sending the message. It should be appreciated that the session border controller (SBC) 106 may receive this information from one or more databases and/or other sources (not shown). Thus, if network element 102a sends a network access request message with a spoofed header pretending to be network element 102b (e.g., the header includes the information associated with a source identifying itself as originating from network element 102b), the session border controller (SBC) 106, when it receives the message from network element 102a, may unconditionally replace the spoofed header with a header including the information associated with network element 102a, which may be the actual source based on the unique identifier of the network element 102a. As a result, the session border controller (SBC) 106 may transmit the message to the proxy 108 and network access may be properly provided to network element 102a, rather than network element 102b. By automatically substituting the header regardless what is presented in the message received, the session border controller (SBC) 106 may effectively prevent the customer from spoofing the proxy 108.

According to an exemplary embodiment, the session border controllers (SBC) 106 may be configured to prevent “spoofing” in a SIP environment. As discussed above, each network element 102 attempting to gain access to the network 104 may have a specific or unique identifier. In one embodiment, the unique identifier may be a vLAN tag.

For example, each network element 102 may be communicatively coupled to a separate wire/link. Each network element 102 may be “multiplexed” onto a wire/link to the session border controllers (SBC) 106 such that the vLAN tag discriminates between each of network element 102 (e.g., network element 102a and network element 102b) and corresponding INVITE messages.

In order for network element 102a to receive network connectivity through proxy 108, a SIP INVITE message may be transmitted from the network element 102a to the session border controller (SBC) 106. The network element 102a may be physically restricted by its unique vLAN tag, e.g., to placing calls to through the network element's SIP endpoint on the session border controller (SBC) 106. This endpoint may contain one or more translation rules for the network element 102a. Similarly, a network element 102b may also be physically restricted by its unique vLAN tag and may, therefore, be allowed to place through the network element's 102b SIP endpoint on the session border controller (SBC) 106. This endpoint may contain one or more translation rules for the network element 102b. Accordingly, when each of network element 102a and 102b seek to gain access to the network 104, a SIP INVITE message with a frame header indicating its unique vLAN tag may be transmitted to the session border controller (SBC) 106 and then to the proxy 108. It should be appreciated that the vLAN tag may not be spoofed because it may be based on a physical link the message came in on. Thus, a customer/subscriber at network element 102a may not access the wire/link of a customer/subscriber at network element 102b because the vLANs are based on separate physical connections.

Because the proxy 108 (e.g., a SIP proxy of a service provider) may key off and/or rely/trust contents of the SIP INVITE message headers to discriminate between network element 102a and network element 102b, it may be possible for the network element 102a to substitute the SIP “From” header of network element 102b header into its own SIP INVITE message and “spoof” the proxy 108 into thinking the phone call is coming from network element 102b.

Accordingly, the translation rules at the session border controller (SBC) 106 may be used to enforce isolation between the vLANs of network element 102a and network element 102b and coerce the SIP message headers to match the customer domain since it may not be possible for a network element 102 to avoid its own coercive translation rule. Thus, in private networks where subscribers/users reside on uniquely assigned vLANs, one or more translation rules used by the session border controller (SBC) 106 may rely on these uniquely assigned vLAN tags/identifiers to discriminate between network element 102a and network element 102b regardless what is actually in the SIP header provided by each network element.

An example SIP message is depicted below with a SIP “From” header used for identification.
INVITE sip:schooler@cs.caltech.edu SIP/2.0
Via: SIP/2.0/UDP north.east.isi.edu
From: Mark Handley <sip:mjh@isi.edu>
To: Eve Schooler <sip:schooler@caltech.edu>
Call-ID: 2963313058@north.east.isi.edu

Here, the domain portion of the SIP “From” header (e.g., after the “@” sign) may be used to identify the party/enterprise originating the communication. This domain portion of the “From” header may be spoofed by another party/enterprise in the event there is no other mechanism to ensure that the header correctly identifies the communicating party. In one embodiment, assuming that “isi.edu” may represent the domain of network element 102a. In this example, a translation rule at the session border controller (SBC) 106 may force the “From” header received from network element 102a to always contain “isi.edu” by rewriting the “From” header domain to “isi.edu” regardless of its original contents.

Depicted below is an exemplary translation rule for vLAN tag/identifier for network element 102a:
match from-domain*replace-with “isi.edu”

Here, the asterisk “*” may match any SIP “From” header domain received from the vLAN of network element 102a and replace the domain field in the SIP “From” header with the domain “isi.edu,” which is the domain that correctly identifies the vLAN of network element 102a.

In another embodiment, one or more translation rules at the session border controller (SBC) 106 may also cause the session border controller (SBC) 106 to deny network access and/or drop the call (e.g., deny the INVITE request message) if it does not include the correct “From” header domain. For example, the session border controller (SBC) 106 may issue a SIP message, such as “404 Not Found.” It should be appreciated that the session border controller (SBC) 106 may deny network access by prevent transmission of the network access request message further downstream. In other embodiments, the session border controller (SBC) 106 may be configured to coordinate with the proxy 108 to deny network access. For example, the session border controller (SBC) 106 may tag the message with a deny request when it transmits the message to the proxy 108.

For example, depicted below is a translation rule at the session border controller (SBC) 106 which may drop the call/communication in the event the SIP “From” header domain does not match the rule:
match from-domain “isi.edu”
if fail return “404 Not Found” to customer CPE and drop call

In some embodiments, the vLAN tag may be part of the data link layer (layer 2) of an Open Source Initiative (OSI) model, as shown in TABLE 1 below.

TABLE 1
OSI Model

| | Data Unit | Layer | Function |
|---|---|---|---|
| Host | Data | 7. Application | Network process to application |
| Layers | | 6. Presentation | Data representation and encryption |
| | | 5. Session | Interhost communication |
| | Segment | 4. Transport | End-to-end connections and |
| | | | reliability |
| Media | Packet | 3. Network | Patent determination and logical |
| Layers | | | addressing |
| | Frame | 2. Data Link | Physical addressing (e.g., MAC, |
| | | | LLC) |
| | Bit | 1. Physical | Media, signal, and binary |
| | | | transmission |

The vLAN tag may be local to customer at a network element 102 facing the session border controller (SBC) 106 and/or may be stripped off by the session border controller (SBC) 106 prior to transmission to the proxy 108. The vLAN tag may be populated by equipment (e.g., router) in hardware/firmware (e.g., of the service provider). The vLAN tag may effectively constitute a separate “virtual” wire/line unique to customer at network element 102a or 102b. Therefore, in the event the user at network element 102a has a vLAN tag, the session border controller (SBC) 106 may identify this vLAN tag coming in on a unique virtual wire/connection from the carrier equipment. Accordingly, the user at network element 102a may not be able to spoof the vLAN tag because the vLAN tag may be part of hardwired connection. Thus, when the service provider identifies that the user is attempting to access the network 104 on a specific wire/link, a unique vLAN tag on layer 2 of the INVITE (and all other) messages up to the session border controller (SBC) 106 may be provided.

It should be appreciated that similar techniques may be applied for a user at network element 102b. The service provider equipment (e.g. router) may identify an INVITE coming in on a specific wire from the user at network element 102b and the router may place a vLAN tag on the INVITE message. The session border controller (SBC) 106 may identify the tagged INVITE message coming from the router with the vLAN tag in layer 2 (datalink layer) and may use the internal translation rule specific to that realm or vLAN tag.

It should be appreciated that the “From” Header may be at the application layer (layer 7). The network element 102 may spoof the “From” header because the network element may function at layer 7 of the OSI model, but it may not spoof the vLAN tag because the vLAN tag may be set by us at layer 2 based on the wire (link) the INVITE comes in on.

Exemplary embodiments may also be applied to network elements not residing on private vLANs but at unique IP addresses in a public setting. Similar to above, the domain portion of the “From” header may be spoofed by another party/enterprise in the event there is no other mechanism to ensure that the header correctly identifies the communicating party. One or more translation rules at the session border controller (SBC) 106 may force the “From” header received from network element 102a to always contain “isi.edu” by rewriting the “From” header domain to “isi.edu” regardless of its original contents. However, in this example, the translation rule at the session border controller (SBC) 106 may check the unique source IP address of the SIP message and apply the translation rule below for that network element:
if source-ip a.a.a.a then
match from-domain*replace-with “isi.edu”

Here, the “a.a.a.a” may be the IP address of the network element 102a. Therefore, once the IP address is recognized by the session border controller (SBC) 106, the translation rule may replace the SIP “From” header domain in the message to the “isi.edu” domain, which is the domain that correctly identifies the IP address of the network element 102a.

It should also be appreciated that while the components of system 100 are shown as separate components, these may be combined into greater or lesser components to optimize flexibility. For example, while the session border controller (SBC) 106 and the proxy 108 are depicted as separate components, it should be appreciated that the session border controller (SBC) 106 and proxy 108 may be integrated into a single component. Other various embodiments may also be realized.

It should be appreciated that each of the components of system 100 (e.g., servers, modules, storage, devices, systems, etc.) may communicate with each other via one or more network communications. The network communication may include the Internet, the World Wide Web, or other similar network for communicatively coupling servers, modules, devices, and/or network systems. The network communication may provide communication ability between the various the components of system 100 via electric, electromagnetic, and/or optical signals that carry digital data streams. For example, the network communication may be a wireless network, a wired network or any combination of wireless network and wired network. For example, the network communication may include, without limitation, Internet network, satellite network (e.g., operating in Band C, Band Ku and/or Band Ka), wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or any other wireless network for transmitting a signal. In addition, the network may include, without limitation, telephone line, fiber optics, IEEE Ethernet 802.3, wide area network (WAN), local area network (LAN), global network such as the Internet. Also, the network communication may enable an Internet network, a wireless communication network, a cellular network, an Intranet, or the like, or any combination thereof. The network communication may further include one, or any number of the exemplary types of networks communications mentioned above operating as a stand-alone network or in cooperation with each other.

It should be appreciated that while exemplary embodiments may provide automatic substitution of the unique identifier in the header portion of messages received at the session border controller (SBC) 106, other types of substitutions may also be provided. For example, substitution may be manual. In this example, the session border controller (SBC) 106 may provide an alert when the unique identifier a message header does not match the unique identifier known by the session border controller (SBC) 106. Here, the alert may be sent for manual review and/or approval before substitution. Other various embodiments may also be provided.

Additionally, it should be appreciated that the session border controller (SBC) 106 may also refuse network access or traffic from unrecognized identifiers, such as unrecognized IP addresses or vLAN identifiers. For example, techniques of exemplary embodiments may be applied to other “identity” SIP header fields as well, such as remote party ID, P-Asserted-Identity, etc.

It should also be appreciated that while embodiments discussed above are primarily directed to SIP headers, the substitution techniques may also be applied to other portions of the message and/or other protocols.

By providing a session border controller (SBC) 106 configured to manipulate content of one or more portions of a message (e.g., by automatically substituting a header portion of the message regardless what is presented in the message received) received from a network element 102, spoofing of the proxy 108 may be prevented. As a result, the session border controller (SBC) 106 may effectively prevent the customer from spoofing the proxy 108.

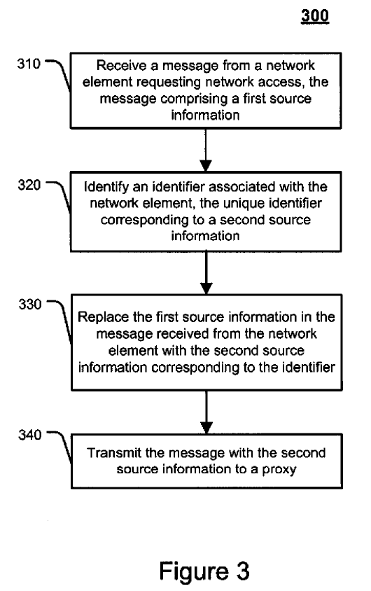

FIG. 3 depicts a flowchart of a method for preventing header spoofing, according to an exemplary embodiment. The exemplary method 300 is provided by way of example, as there are a variety of ways to carry out methods disclosed herein. The method 300 shown in FIG. 3 may be executed or otherwise performed by one or a combination of various systems. The method 300 is described below as carried out by at least system 100 in FIG. 1, by way of example, and various elements of systems 100 are referenced in explaining the example method of FIG. 3. Each block shown in FIG. 3 represents one or more processes, methods, or subroutines carried in the exemplary method 300. A computer readable media comprising code to perform the acts of the method 300 may also be provided. Referring to FIG. 3, the exemplary method 300 may begin at block 310.

At block 310, a message from a network element 102 may be received. For example, a receiver at the session border controller (SBC) 106 may receive a message from a network element 102. The message may be a request for network access. The message may also comprise a first source information. It should be appreciated that as used herein, “first source information” may be information associated with the source of the network access. In this example, the first source information may be information encoded in a header portion of the message. In other embodiments, the first source information may comprise domain information. Additionally, in yet other embodiments, the message may be a Session Initiation Protocol (SIP) message.

At block 320, a unique identifier may be identified. For example, one or more processors at the session border controller (SBC) 106 may identify a unique identifier associated with the network element 102. The unique identifier may correspond to a second source information. It should be appreciated that as used herein, “second source information” may be information associated with the source of the network access. In this example, the second source information may be information corresponding to the unique identifier that the session border controller (SBC) 106 may accurately associate with the network element. Similar to the first source information, the second source information may also comprise domain information. It should be appreciated that the second source information may or may not be the same as the first source information. In the event that the second source information is different than the first source information, there may be a possible “spoof.”

In some embodiments, the one or more processors may identify the unique identifier by using one or more translation rules of the session border controller (SBC) 106 to determine the second source information corresponding to the unique identifier of the network element. In other embodiments, the one or more translation rules and/or the second source information may be stored in one or more databases (not shown), which may be communicatively coupled to the session border controller (SBC) 106. It should be appreciated that the unique identifier may be at a vLAN tag, an Internet Protocol (IP) address, and/or other similar identifier, e.g., a remote party ID, a P-Asserted-Identity (PAI), etc.

At block 330, the first source information may be replaced with the second source information. For example, one or more processors at the session border controller (SBC) 106 may replace the first source information in the message (e.g., in the header portion of the message) received from the network element 102 with the second source information (e.g., correct domain information) corresponding to the unique identifier of the network element. Replacing the first source information with the second source information in the message may be automatic or manual. Whether the first source information is different than the second source information or not, it should be appreciated that by replacing the first source information with the second source information, which may be regarded as the source information corresponding to the network element 102, the message containing the second source information may be trusted and relied upon by the proxy 108.

At block 340, the message containing the second source information may be transmitted. For example, a transmitter at the session border controller (SBC) 106 may transmit the message with the second source information to a proxy 108. In some embodiments, the proxy may be a service provider proxy configured to grant and/or deny network access.

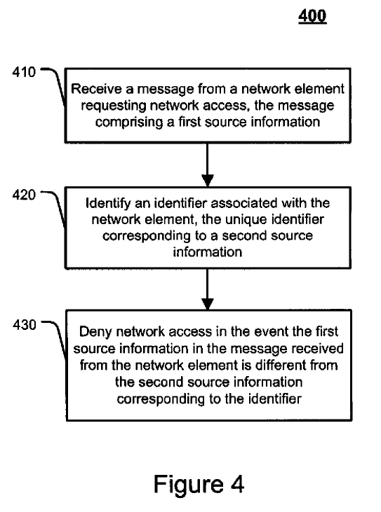

FIG. 4 depicts a flowchart of a method for preventing header spoofing using vLAN information, according to an exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 100 in FIG. 1, by way of example, and various elements of systems 100 are referenced in explaining the example method of FIG. 4. Each block shown in FIG. 4 represents one or more processes, methods, or subroutines carried in the exemplary method 400. A computer readable media comprising code to perform the acts of the method 400 may also be provided. Referring to FIG. 4, the exemplary method 400 may begin at block 410.

At block 410, a message from a network element 102 may be received. For example, a receiver at the session border controller (SBC) 106 may receive a message from a network element 102. The message may be a request for network access. The message may also comprise a first source information. In some embodiments, the first source information may be encoded in a header portion of the message. In other embodiments, the first source information may comprise domain information. Additionally, in yet other embodiments, the message may be a Session Initiation Protocol (SIP) message.

At block 420, a unique identifier may be identified. For example, one or more processors at the session border controller (SBC) 106 may identify a unique identifier associated with the network element 102. The unique identifier may correspond to a second source information. In one embodiment, the second source information may comprise domain information. In some embodiments, the one or more processors may identify the unique identifier by using one or more translation rules of the session border controller (SBC) 106 to determine the second source information corresponding to the unique identifier of the network element. In other embodiments, the one or more translation rules and/or the second source information may be stored in one or more databases (not shown), which may be communicatively coupled to the session border controller (SBC) 106. It should be appreciated that the unique identifier may be at a vLAN tag, an Internet Protocol (IP) address, and/or other similar identifier for selecting the second source information, e.g., a remote party ID, a P-Asserted-Identity (PAI), etc.

At block 430, network access may be denied. For example, one or more processors at the session border controller (SBC) 106 may deny network access in the event it is determined that the first source information in the message received from the network element with the second source information corresponding to the unique identifier of the network element are different. In some embodiments, denying network access may further comprise coordinating with a service provider proxy. In other embodiments, the session border controller (SBC) 106 may halt downstream transmission of the message and/or place one or more tags on the message to indicate network access not permitted.

By performing the various features and functions as discussed above, the systems and methods described above may allow secure communications over a network by preventing spoofing of subscriber-side devices.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A computer-implemented method, comprising:
receiving, at an session border controller (SBC), a message from a network element, wherein the message is a request for network access and the message comprises a first source information;
identifying, at the session border controller (SBC), an identifier associated with the network element, wherein the identifier corresponds to a second source information;
replacing, at the session border controller (SBC), the first source information in the message received from the network element with the second source information corresponding to the identifier of the network element; and
transmitting, from the session border controller (SBC), the message with the second source information to a proxy.

2. The method of claim 1, wherein the message is a Session Initiation Protocol (SIP) message.

3. The method of claim 1, wherein the first source information is encoded in a header portion of the message.

4. The method of claim 1, wherein the first source information the second source information comprise domain information.

5. The method of claim 1, wherein identifying the identifier comprises using one or more translation rules of the session border controller (SBC) to determine the second source information corresponding to the identifier of the network element.

6. The method of claim 5, wherein at least the one or more translation rules and the second source information are stored in one or more databases.

7. The method of claim 1, wherein the identifier is at least one of a vLAN tag, an Internet Protocol (IP) address, a remote party ID, and a P-Asserted-Identity (PAI).

8. The method of claim 1, wherein replacing the first source information with the second source information in the message is automatic.

9. The method of claim 1, wherein the proxy is a service provider proxy configured to grant or deny network access.

10. A computer readable media comprising code to perform the acts of the method of claim 1.

11. A computer-implemented system, comprising:
a receiver configured to receive a message from a network element, wherein the message is a request for network access and the message comprises a first source information;
one or more processors configured to identify an identifier associated with the network element, wherein the identifier corresponds to a second source information, and to replace the first source information in the message received from the network element with the second source information corresponding to the identifier of the network element;
one or more databases configured to store the second source information; and
a transmitter configured to transmit the message with the second source information to a proxy for granting network access.

12. A computer-implemented method, comprising:
receiving, at a session border controller (SBC), a message from a network element, wherein the message is a request for network access and the message comprises a first source information;
identifying, at the session border controller (SBC), a identifier associated with the network element, wherein the identifier corresponds to a second source information; and
deny network access in the event it is determined that the first source information in the message received from the network element with the second source information corresponding to the identifier of the network element are different.

13. The method of claim 12, wherein the message is a Session Initiation Protocol (SIP) message.

14. The method of claim 12, wherein the first source information is encoded in a header portion of the message.

15. The method of claim 12, wherein the first source information the second source information comprise domain information.

16. The method of claim 12, wherein identifying the identifier comprises using one or more translation rules of the session border controller (SBC) to determine the second source information corresponding to the identifier of the network element.

17. The method of claim 5, wherein at least the one or more translation rules and the second source information are stored in one or more databases.

18. The method of claim 12, wherein the identifier is at least one of a vLAN tag, an Internet Protocol (IP) address, a remote party ID, and a P-Asserted-Identity (PAI).

19. The method of claim 12, wherein denying network access further comprises coordinating with a service provider proxy.

20. A computer readable media comprising code to perform the acts of the method of claim 12.

21. A computer-implemented system, comprising:
a receiver configured to receive a message from a network element, wherein the message is a request for network access and the message comprises a first source information;
one or more processors configured to identify a identifier associated with the network element, wherein the identifier corresponds to a second source information, and to deny network access in the event it is determined that the first source information in the message received from the network element with the second source information corresponding to the identifier of the network element are different.
